(19) United States
(12) Patent Application Publication
(10) Pub. No.: US 2023/0107452 A1
(43) Pub. Date: Apr. 6, 2023

(54) A New Interlayer Can Withstand Polarity Reversal

(71) Applicant: Magneto Special Anodes (Suzhou) CO., LTD., Jiangsu (CN)

(72) Inventors: Junwei Xue, Jiangsu (CN); Qite Zhao, Jiangsu (CN); Hongyuan Chen, Jiangsu (CN)

(73) Assignee: Magneto Special Anodes (Suzhou) CO., LTD., Jiangsu (CN)

(21) Appl. No.: 17/800,530

(22) PCT Filed: Feb. 18, 2021
(86) PCT No.: PCT/CN2021/076713

§ 371 Date: Aug. 17, 2022

(30) Foreign Application Priority Data
Feb. 17, 2020 (CN) 202010097095.9

(51) Int. Cl. C25B 11/036; C25B 11/063; C25B 11/097; C25B 1/02

(52) U.S. Cl. CPC C25B 11/036; C25B 1/02; C25B 11/063; C25B 11/097

(57) ABSTRACT

The application discloses an electrode having polarity capable of being reversed and use thereof. The electrode includes a substrate comprising a metal or an alloy thereof; an intermediate layer arranged on the substrate and comprising a platinum group metal and a platinum group metal oxide; and a catalytic layer arranged on the intermediate layer and comprising a mixed metal oxide. The electrode may be used as an electrode for electrolysis, electrodialysis or electroplating. The electrode can simultaneously meet the working environment requirements of the cathode and the anode, which improves the environmental tolerance and realizes the protection of the substrate; and can carry out polarity reversal to clean deposits on the surface of the electrode quickly and efficiently.

### TECHNICAL FIELD

The application relates to, but is not limited to, the field of electrochemistry, in particular to, but is not limited to, an electrode having polarity capable of being reversed and use thereof.

### BACKGROUND

An oxygen-evolution titanium electrode, as an environment-friendly insoluble anode, has been widely used in electrochemical industry, mainly focusing on fine finishing processes such as electrochemical water treatment, metal element extraction, and electroplating. The oxygen-evolution titanium electrode is mainly composed of pure metal titanium or titanium alloy substrate and noble metal oxide catalyst layer on its surface. The substrate provides conductive and mechanical support. The catalyst layer can greatly reduce the oxygen-evolution potential in aqueous solution through its own redox process to achieve the effect of energy saving. At the same time, the anode has a long service life depending on its extremely low electrochemical consumption rate. The oxygen-evolution catalyst is mainly iridium oxide, which can be mixed with an oxide of valve-type metal such as titanium, tantalum or niobium to make the coating denser to protect the substrate from passivation too quickly. Sometimes an alloy or a mixed oxide of valve-type metals such as titanium or tantalum or alloy is also used as an intermediate layer to be interposed between the catalyst layer and the substrate to protect the substrate.

During the electrolysis process, some deposits will inevitably be deposited on the surface of the electrode, which will affect the electrolysis efficiency of the electrode and even lead to the failure of the electrode. Therefore, it is very necessary to clean the deposits on the surface of the electrode regularly.

The anode surface is in an acidic environment due to the oxygen-evolution reaction and the cathode surface is an alkaline environment due to the hydrogen-evolution reaction. Sediments produced in the acidic environment are generally easy to be removed under alkaline conditions, and vice versa. In chlorine-evolution electrodes (partially oxygen evolution) , deposits on the surface of the electrode can be removed by reversing the polarity of the electrodes. However, for oxygen-evolution electrodes, the current products cannot reach the acceptable life level after the reversal. During the investigation of the failure of anodes under polarity reversal, it is found that though the stability of the valve metal oxide in the coating is one explaination for the short lifetime, the main reason comes from the substrate, or the interface between the coating and substrate. It is assumed that the corrosion rate of the substrate is greatly accelerated, titanium hydride is generated at the same time, and the coating will fall off due to the density-volume change, because when the substrate material of conventional electrode (such as titanium metal or titanium alloy) is used as the cathode,.

In the open publication, the eletrochemical response of Ti in aqueous solutions falls somewhere between that of the true valve metals(e.g., Zr, Nb, Ta) and that of the active-passive metals(e.g., Fe, Co, Ni, Cr). In particular, its oxide film formation resembles that of valve metals, while its corrosion is similar to corrosion of active-passive metals. A schematic illustratin of the current -potential relationship for Ti in acidic electrolyte was mentioned by James J. Noel(The electrochemistry of Titanium corrosion, 1999, University of Manitoba, Doctor thesis) and is presented in FIG. 1

In the active region, Ti can be oxidized at a relatively high rate, forming Ti(III) ions in solution, and in the passive region, Ti is covered by the oxide film and can be oxidized only very slowly. In the anode applicaiton, the active state should be avoided and it is better that the anode works in the passive state. Alloying could be used to generate passivity on Ti and it can work in two ways: by inhibiting the anodic half-reaction, or by enhancing the cathodic half-reaction. Alloying elements that have been suggested to induce passivity of Ti by cathodic modification include Pt, Pd, Ni, Mo, etc. In the work of M. Nakagawa etc, (The effect of Pt and Pd alloying additions on the corrosion behavior of titanium in flfluoride-containing environments, Biomaterials 26 (2005) 2239-2246), it is clearly demonstrated that by alloying with Pt and Pd, the active region of Ti is almost gone as illustrated by FIG. 2. and FIG. 3..

The noble metal oxide coating is relatively stable whether being anode or being cathode. But due to the thermal decomposition process, there exists a lot of crack, or more generally defects. In normal oxygen evolution application, the low pH produced by the anode reaction greatly accelerate the corrosion of the substrate and as a common solution, a Ta oxide type interlayer is used, and greatly increase the service lifetime. But inventors founded that this type of interlayer can not solve the lifetime problem of polarity reversal.

Based on the above understanding, for anode in polarity reversal application, a new coating structure is needed to solve the substrate problem incountered during cathodic polarization, and increase the lifeitme under oxygen evolving and polarity reversal applications.

In addition, some applications also require the electrode to have the function of reversing the polarity of the electrode, such as electrodialysis membrane stack. In order to maintain the performance of the membrane stack, the polarity of the electrode needs to be periodically reversed. However, the use of chlorine-evolution electrode and sodium chloride polar solution will lead to the pollution problem of relatively large chlorine.

### SUMMARY

The following is an overview of the subject matter described in detail herein. This summary is not intended to limit the scope of protection of the claims.

In order to quickly and efficiently clean unnecessary deposits on the surface of the electrode and find a suitable oxygen-evolution electrode having polarity capable of being reversed for use in fields requiring periodic polarity reversal of the electrode, inventors of the application have improved the electrode structure through years of careful research, especially based on the contents described in FIGS. 1-3, it was hypothesized that and interlayer based on a Pt group metal, without Ta, may improve the stability under cathodic polarization and continuous polarity reversal.

The application provides an electrode having polarity capable of being reversed including a substrate, an intermediate layer, and a catalytic layer, the substrate may include a metal or an alloy thereof; the intermediate layer is arranged on the substrate and may include a platinum group metal and a platinum group metal oxide; the catalytic layer is arranged on the intermediate layer and may include a mixed metal oxide.

In some embodiments, the intermediate layer may include a mixture of metal platinum and iridium dioxide. The sum of the content of platinum and iridium may be 1 g/m²-30 g/m², for example, 2 g/m², 3 g/m², 4 g/m², 5 g/m², 7.5 g/m², 8 g/m², 10 g/m², 12 g/m², 15 g/m², 18 g/m², 22 g/m², 25 g/m², 28 g/m² etc., based on the metal content. The platinum content (based on the metal content) may be 10 wt%-90 wt%, for example, 20 wt%, 30 wt%, 40 wt%, 50 wt%, 60 wt%, 70 wt%, 80 wt%, etc., based on the total metal content of the intermediate layer. The iridium content may be 10 wt%-90 wt%, for example, 20 wt%, 30 wt%, 40 wt%, 50 wt%, 60 wt%, 70 wt%, 80 wt%, etc., based on the total metal content of the intermediate layer. Alternatively, the platinum content (based on the metal content) may be 40 wt%-90 wt%, for example, 50 wt%, 60 wt%, 70 wt%, 80 wt%, etc., based on the total metal content of the intermediate layer; and the iridium content may be 10 wt%-60 wt%, for example, 20 wt%, 30 wt%, 40 wt%, 50 wt%, etc., based on the total metal content of the intermediate layer.

In some embodiments, the intermediate layer may also contain a metal oxide of any one or more of ruthenium, palladium, and rhodium. The content of metal ruthenium, palladium, rhodium (based on the metal content) of the intermediate layer may be each less than 10 wt%, for example, 1 wt%, 2 wt%, 5 wt%, 8 wt%, etc., based on the total metal content of the intermediate layer.

In some embodiments, the platinum group metal of the intermediate layer may diffuse into the substrate to form a mixed transition layer. Diffusion can be performed by means of heat treatment, such as sintering.

In some embodiments, the catalytic layer may include a metal oxide of iridium, and may also include a mixed metal oxide of tantalum and iridium, and may also include tantalum pentoxide and iridium dioxide. The iridium content of the catalytic layer may be 3 g/m²-100 g/m², for example, 5 g/m², 8 g/m², 10 g/m², 15 g/m², 20 g/m², 22 g/m², 25 g/m², 30 g/m², 35 g/m², 40 g/m², 50 g/m², 60 g/m², 70 g/m², 80 g/m², 90 g/m², based on the metal content. The iridium content (based on the metal content) may be 20 wt%-90 wt%, for example, 30 wt%, 40 wt%, 50 wt%, 60 wt%, 70 wt%, 80 wt%, etc., based on the total metal content of the catalytic layer. The tantalum content (based on the metal content) may be 10 wt%-80 wt%, for example, 20 wt%, 30 wt%, 40 wt%, 50 wt%, 60 wt%, 70 wt%, etc., based on the total metal content of the catalytic layer.

In some embodiments, the catalytic layer may further contain a metal oxide of any one or more of ruthenium, palladium, rhodium, titanium, niobium, zirconium, hafnium, vanadium, molybdenum, and tungsten. The content of ruthenium, palladium, rhodium, titanium, niobium, zirconium, hafnium, vanadium, molybdenum, tungsten (based on the metal content) in the catalytic layer is each less than 10 wt%, for example, 1 wt%, 2 wt%, 5 wt%, 8 wt%, etc., based on the total metal content of the catalytic layer.

In some embodiments, the substrate may be a valve-type metal or an alloy of valve-type metals. The valve-type metal may be selected from one or more of titanium, tantalum, niobium, zirconium, hafnium, vanadium, molybdenum and tungsten. For example, the substrate may be metallic titanium or titanium alloy.

The application also provides use of an electrode having polarity capable of being reversed, which can be used as an electrode for electrolysis, electrodialysis or electroplating.

In some embodiments, the electrode may be an oxygen-evolution electrode.

Compared with the prior art, the application has the beneficial effects that:
(1) an intermediate layer containing a platinum group metal and a platinum group metal oxide is arranged so that the firm combination between the substrate and the intermediate layer is ensured, and the corrosion resistance of the substrate when being used as a cathode is improved;
(2) the prepared electrode is more tolerant towards organic solutions and can be used in a wider range of operating conditions;
(3) the electrode can simultaneously meet the working environment requirements of the cathode and the anode, which improves the environmental tolerance and realizes the protection of the substrate;
(4) the prepared electrode has polarity capable of being reversed so as to quickly and efficiently clean deposits on the surface of the electrode; and
(5) the oxygen-evolution electrode can still maintain an excellent electrode life when the polarity is periodically reversed, and can be applicable in fields requiring periodically reversing the polarity of the electrode.

Other features and advantages of the application will be set forth in the following description, and partly become apparent from the description, or be understood by implementing the invention. The purpose and other advantages of the application can be achieved and obtained by means of the structure specifically indicated in the description, claims and drawings.

### BRIEF DESCRIPTION OF DRAWINGS

Drawings are for further understanding of the technical schemes of the application and constitute a part of the description, are used for explaining the technical schemes of the application in combination with the embodiments of the application, but not for limiting the technical schemes of the invention.

FIG. 1 is a schematic diagram of current-potential relationship for Ti in acidic electrolyte;

FIG. 2 is anodic polarization curves of Ti and its alloys in the artificial saliva containing 0.2% NaF at a pH of 4.0;

FIG. 3 is anodic polarization curves of Ti—Pt alloys in the artifificial saliva containing 0.2% NaF at a pH of 4.0;

FIG. 4 is a schematic diagram of an electrode structure according to an example of the application.

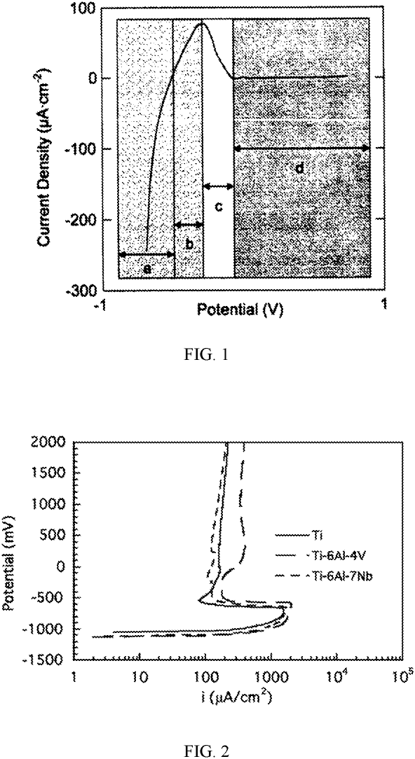

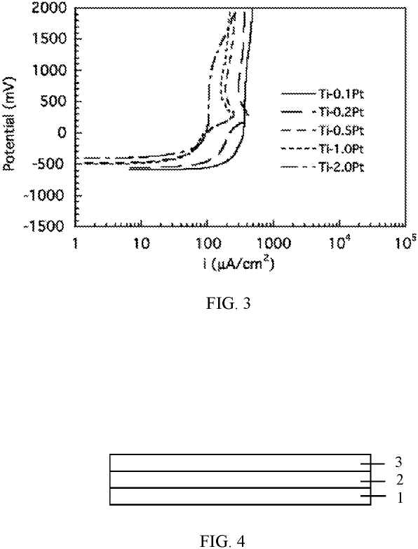

In the figures: a: hydrogen evolution region; b: active region; c:active to passive transition d: passive region; 1. Substrate; 2. Intermediate layer; 3. Catalytic layer.

### DETAILED DESCRIPTION

In order to make the object, technical scheme and advantages of this application clearer, Examples of this application will be described in detail below with reference to the accompanying drawings. It should be noted that Examples in this application and the features in the Examples can be combined with each other arbitrarily without conflict.

An Example of the application provides an electrode having polarity capable of being reversed, for example, as shown in FIG. 4, the electrode includes a substrate 1, an intermediate layer 2, and a catalytic layer 3, which are sequentially stacked from bottom to top.

The intermediate layer 2 and the catalytic layer 3 may also be symmetrically arranged on both sides of the substrate 1.

The substrate 1 may be a valve-type metal or an alloy of valve-type metals. The valve-type metal may be selected from one of titanium, tantalum, niobium, zirconium, hafnium, vanadium, molybdenum and tungsten. For example, the substrate 1 may be metallic titanium or titanium alloy.

The substrate 1 may be pretreated, for example, by conventional etching or sand blasting combined with pickling.

The intermediate layer 2 may include a platinum group metal and a platinum group metal oxide and may be a mixture of metal platinum and iridium dioxide, and the intermediate layer 2 may also include a metal oxide of any one or more of ruthenium, palladium and rhodium. The sum of the content of platinum and iridium may be 1 g/m²-30 g/m², based on the metal content. The platinum content (based on the metal content) may be 10 wt%-90 wt%, and the iridium content (based on the metal content) may be 10 wt%-90 wt%, based on the total metal content of the intermediate layer; the content of metal ruthenium, palladium and rhodium (based on the metal content) is each less than 10 wt%, based on the total metal content of the intermediate layer. Alternatively, The platinum content (based on the metal content) may be 40 wt%-90 wt%, and the iridium content (based on the metal content) may be 10 wt%-60 wt%, based on the total metal content of the intermediate layer; the content of metal ruthenium, palladium and rhodium (based on the metal content) is each less than 10 wt%, based on the total metal content of the intermediate layer.

The platinum group metal used in the intermediate layer 2 has a higher oxygen-evolution potential than that of the material used in the catalytic layer 3, thus ensuring that the substrate of the electrode is not passivated under the oxygen-evolution condition. At the same time, due to the presence of metal platinum, the intermediate layer 2 has stable performance under hydrogen-evolution conditions and high tolerance to the working environment of the cathode. Therefore, the intermediate layer 2 can simultaneously meet the protection of the substrate when the cathode and the anode work, so that the electrode is capable of being used when its polarity is reversed, thereby quickly and efficiently cleaning deposits on the surface of the electrode and being applicable in fields requiring periodically reversing the polarity of the electrode.

The intermediate layer 2 is formed by coating precursor solution containing corresponding elements, drying and then sintering. The precursor of platinum exists in the metal state in the subsequent sintering process, which makes the diffusion of metal platinum to the substrate 1 (e.g., titanium) easier. However, the coating of pure metal platinum has poor stability in a highly acidic environment. Adding a certain amount of iridium (converted into iridium dioxide during sintering) can improve the stability of the intermediate layer in the highly acidic environment generated by oxygen evolution.

The precursor for preparing the intermediate layer 2 is formulated as a coating solution, for example chloroplatinic acid and chloroiridic acid can be formulated into a coating solution in hydrochloric acid solution, in which the platinum content may be 2.0 wt%-6.0 wt%, for example, 3.0 wt%, 4.0 wt%, 4.2 wt%, 4.8 wt%, 5.0 wt%, etc.. A certain amount of coating solution is applied to the pretreated substrate 1 by conventional coating methods, such as brushing, roller coating, spraying, etc.. The coated substrate 1 is dried in air or in an oven at 60° C.-90° C., for example at 80° C., and then sintered in an air circulation electric furnace at 400° C.-600° C. for 10-30 minutes, for example at 500° C. for 20 minutes. Multiple coating and sintering can be carried out, and once sintering is carried out after each coating. During the sintering process, chloroplatinic acid is decomposed into metal platinum and a small amount of platinum oxide, and chloroiridic acid is decomposed into iridium dioxide. The mixture of platinum and iridium dioxide can also be directly coated to the substrate 1 by other chemical vapor deposition or even physical vapor deposition methods.

The catalytic layer 3 may include a metal oxide of iridium, and may also include a mixed metal oxide of tantalum and iridium; for example, the catalytic layer 3 may include tantalum pentoxide and iridium dioxide. The catalytic layer 3 may also include a metal oxide of any one or more of ruthenium, palladium, rhodium, titanium, niobium, zirconium, hafnium, vanadium, molybdenum, and tungsten. The iridium content of the catalytic layer may be 3 g/m²-100 g/m², based on the metal content. The iridium content (based on the metal content) may be 20 wt%-90 wt%, and the tantalum content (based on the metal content) may be 10 wt%-80 wt%, based on the total metal content of the catalytic layer. The content of metal ruthenium, palladium, rhodium, titanium, niobium, zirconium, hafnium, vanadium, molybdenum and tungsten is each less than 10 wt%, based on the total metal content of the intermediate layer.

The method for preparing the catalytic layer 3 is similar to the method for preparing the intermediate layer 2, for example, chloroiridic acid and tantalum pentachloride may be used as precursors, and the coating solution may be prepared in hydrochloric acid solution.

The intermediate layer 2 or the catalytic layer 3 may also contain other elements, and can be prepared by adding precursors of the corresponding elements to the corresponding coating solution, and chlorides of other elements may generally be added.

After the intermediate layer 2 is prepared on the substrate 1, the substrate 1 and the intermediate layer 2 may be subjected to heat treatment so that some metal elements of the intermediate layer 2 can diffuse into the substrate 1. The firm combination between the substrate 1 and the intermediate layer 2 is ensured, and the corrosion resistance of the substrate 1 when being used as a cathode is also improved. The heat treatment may be to sinter the substrate 1 and the intermediate layer 2 in an air circulation electric furnace at 500° C.-600° C. for 3-6 hours, for example, at 530° C. for 4 hours.

### Example 1

Gr1 grade industrial pure titanium was used as a substrate, subjected to the heat treatment at 500° C. for 1 hour, then etched in 30.0 wt% sulfuric acid at 90° C. for 4 hours, washed in ultra-pure water by an ultrasonic device and dried in the air.

A coating solution for an intermediate layer was fomulated as a hydrochloric acid solution containing chloroiridic acid and chloroplatinic acid. Based on the metal content, the mass ratio of platinum to iridium was 8:2, the platinum content was 4.8 wt%, and the concentration of HCl was 10.0 wt% (added as saturated hydrochloric acid). The coating solution for the intermediate layer was coated on the metal titanium substrate for 4 times by a thermal decomposition method (the total amount of platinum and iridium was 1.0 g/m², based on the metal content, for each coating), and the thermal decomposition was carried out at 500° C. for 20 minutes after each coating, to obtain the intermediate layer containing metal platinum and iridium dioxide. The total amount of platinum and iridium in the intermediate layer was 4.0 g/m², based on the metal content.

The substrate and the intermediate layer were sintered at 530° C. for 4 hours.

A coating solution for a catalytic layer was fomulated as a hydrochloric acid solution containing chloroiridic acid and tantalum pentachloride. Based on the metal content, the mass ratio of iridium to tantalum was 7:3, the iridium content was 6.0 wt%, and the concentration of hydrochloric acid was 10.0 wt%. The coating solution for the catalyst layer was coated to the intermediate layer for 10 times by a thermal decomposition method (the amount of iridium was 1.0 g/m², based on the metal content, for each coating). The thermal decomposition was carried out at 450° C. for 20 minutes after each coating, to obtain the catalytic layer containing mixed metal oxide of tantalum pentoxide and iridium dioxide. The total amount of iridium in the catalytic layer was 10.0 g/m², based on the metal content.

### Comparative Example 1

Gr1 grade industrial pure titanium was used as a substrate, subjected to the heat treatment at 500° C. for 1 hour, then etched in 30.0 wt% sulfuric acid at 90° C. for 4 hours, washed in ultra-pure water by an ultrasonic device and dried in the air.

A coating solution for an intermediate layer was fomulated as a hydrochloric acid solution containing tantalum chloride. Based on the metal content, the tantalum content was 6.0 wt% and the concentration of hydrochloric acid was 10.0 wt%. The coating solution for the intermediate layer was coated on the metal titanium substrate for 3 times by a thermal decomposition method (the total amount of tantalum was 1.0 g/m², based on the metal content, for each coating), and the thermal decomposition was carried out at 520° C. for 20 minutes after each coating, to obtain the intermediate layer containing tantalum pentoxide. The tantalum content in the intermediate layer was 3.0 g/m², based on the metal content.

A coating solution for a catalytic layer was fomulated as a hydrochloric acid solution containing chloroiridic acid and tantalum pentachloride. Based on the metal content, the mass ratio of iridium to tantalum was 7:3, the iridium content was 6.0 wt%, and the concentration of hydrochloric acid was 10.0 wt%. The coating solution for the catalyst layer was coated to the intermediate layer for 14 times by a thermal decomposition method (the amount of iridium was 1.0 g/m², based on the metal content, for each coating). The thermal decomposition was carried out at 450° C. for 20 minutes after each coating, to obtain the catalytic layer containing a mixed metal oxide of tantalum pentoxide and iridium dioxide. The total amount of iridium in the catalytic layer was 14.0 g/m², based on the metal content.

### Performance Test

The positive polarity and negative polarity and current output of the rectifier were controlled by software, and the life test of the electrode was carried out under the following conditions.

### Test 1

The test conditions were: 5000 A/m², 15% sulfuric acid electrolyte, the time interval of polarity reversal was 5 min (i.e., during the test, the rectifier was subjected to the polarity reversal every 5 min).

The accelerated life of the electrode of Example 1 was 6.1 Mah/m²;

The accelerated life of the electrode of Comparative Example 1 was 0.3 Mah/m².

### Test 2

The test conditions were: 45000 A/m², 80° C., 25% sulfuric acid electrolyte, without polarity reversal.

The accelerated life of the electrode of Example 1 was 40.0 Mah/m²;

The accelerated life of the electrode of Comparative Example 1 was 35.0 Mah/m².

Accelerated life refers to a method for evaluating the performance of an electrode by enabling the electrode to reach the end of life faster than the actual work under more rigorous environments such as higher current, higher temperature, higher acidity, etc. than the actual work.

In the process of polarity reversal of the electrode, most of the deposits on the electrode are cleaned, thus realizing self-cleaning of the oxygen-evolution electrode and prolonging the service life of the electrode.

From the results of Test 1 and Test 2 of Comparative Example 1 described above, it can be seen that the accelerated life of the electrode using tantalum pentoxide as the intermediate layer is dramatically reduced and thus the electrode performance cannot meet the application requirements, in the polarity periodic reversal application.

Comparing the electrode of Example 1 using metal platinum and iridium dioxide as the intermediate layer with the electrode of Comparative Example 1 using common tantalum pentoxide as the intermediate layer, under the condition of direct current (without electrode reversal test, Test 2), the service life of the electrode of Example 1 is slightly improved as compared with the service life of the electrode of Comparative Example 1; however, in the case of polarity reversal (Test 1), the service life of the electrode of Example 1 is significantly prolonged as compared with the service life of the electrode of Comparative Example 1.

### Example 2

Gr1 grade industrial pure titanium was used as a substrate, subjected to the heat treatment at 500° C. for 1 hour, then etched in 30.0 wt% sulfuric acid at 90° C. for 4 hours, washed in ultra-pure water by an ultrasonic device and dried in the air.

A coating solution for an intermediate layer was fomulated as an n-butanol solution containing chloroiridic acid and chloroplatinic acid. Based on the metal content, the mass ratio of platinum to iridium was 7:3, the platinum content was 4.2 wt%, the concentration of HCl was 2.0 wt% (added as saturated hydrochloric acid), and the remaining component was n-butanol. The coating solution for the intermediate layer was coated on the metal titanium substrate for 8 times by a thermal decomposition method (the total amount of platinum and iridium was 1.25 g/m², based on the metal content, for each coating), and the thermal decomposition was carried out at 500° C. for 20 minutes after each coating, to obtain the intermediate layer containing metal platinum and iridium dioxide. The total amount of platinum and iridium in the intermediate layer was 10.0 g/m², based on the metal content.

The substrate and the intermediate layer were sintered at 540° C. for 6 hours.

A coating solution for a catalyst layer was formulated as n-butanol solution containing chloroiridic acid and tantalum ethoxide. Based on the metal content, the mass ratio of iridium to tantalum was 7:3, the iridium content was 5.0 wt%, the concentration of HCl was 2.0 wt% (added as saturated hydrochloric acid), and the remaining component was n-butanol. The coating solution for the catalyst layer was coated to the intermediate layer for 8 times by a thermal decomposition method (the amount of iridium was 1.0 g/m², based on the metal content, for each coating). The thermal decomposition was carried out at 450° C. for 20 minutes after each coating, to obtain the catalytic layer containing a mixed metal oxide of tantalum pentoxide and iridium dioxide. The total amount of iridium in the catalytic layer was 8.0 g/m², based on the metal content.

### Comparative Example 2

Gr1 grade industrial pure titanium was used as a substrate, subjected to the heat treatment at 500° C. for 1 hour, then etched in 30.0 wt% sulfuric acid at 90° C. for 4 hours, washed in ultra-pure water by an ultrasonic device and dried in the air.

A coating solution for an intermediate layer was fomulated as n-butanol solution containing tantalum ethoxide. Based on the metal content, the tantalum content was 6.0 wt%. The coating solution for the intermediate layer was coated on the metal titanium substrate for 3 times by a thermal decomposition method (the total amount of tantalum was 1.0 g/m², based on the metal content, for each coating), and the thermal decomposition was carried out at 500° C. for 20 minutes after each coating, to obtain the intermediate layer containing tantalum pentoxide. The tantalum content in the intermediate layer was 3.0 g/m², based on the metal content.

A coating solution for a catalyst layer was formulated as n-butanol solution containing chloroiridic acid and tantalum ethoxide. Based on the metal content, the mass ratio of iridium to tantalum was 7:3 and the iridium content was 6.0 wt%. The coating solution for the catalyst layer was coated to the intermediate layer for 18 times by a thermal decomposition method (the amount of iridium was 1.0 g/m², based on the metal content, for each coating). The thermal decomposition was carried out at 480° C. for 20 minutes after each coating, to obtain the catalytic layer containing a mixed metal oxide of tantalum pentoxide and iridium dioxide. The total amount of iridium in the catalytic layer was 18.0 g/m², based on the metal content.

### Performance Test

The positive polarity and negative polarity and current output of the rectifier were controlled by software, and the life test of the electrode was carried out under the following conditions.

### Test 1

The test conditions were: 5000 A/m², 15% sulfuric acid electrolyte, the time interval of polarity reversal was 5 min.

The accelerated life of the electrode of Example 2 was 10.8 Mah/m²;

The accelerated life of the electrode of Comparative Example 2 was 0.2 Mah/m².

### Test 2

The test conditions were: 45000 A/m², 80° C., 25% sulfuric acid electrolyte, without polarity reversal.

The accelerated life of the electrode of Example 2 was 68 Mah/m²;

The accelerated life of the electrode of Comparative Example 2 was 52.0 Mah/m².

Similarly, in the process of polarity reversal of the electrode, most of the deposits on the electrode are cleaned, thus realizing self-cleaning of the oxygen-evolution electrode. In addition, as compared with Comparative Example 2, Example 2 has an improved service life under the condition of direct current, but has a greatly prolonged life under the condition of polarity reversal.

### Example 3

Gr1 grade industrial pure titanium was used as a substrate, subjected to the heat treatment at 500° C. for 1 hour, then etched in 7.5 wt% oxalic acid at 90° C. for 1 hour, cooled to 80° C. and continued to etch for 12 hours, washed in ultra-pure water by an ultrasonic device and dried in the air.

A coating solution for an intermediate layer was fomulated as an n-butanol solution containing chloroiridic acid and chloroplatinic acid. Based on the metal content, the mass ratio of platinum to iridium was 5:5, the platinum content was 3.0 wt%, the concentration of hydrochloric acid was 2.0 wt% (added as saturated hydrochloric acid), and the remaining component was n-butanol. The coating solution for the intermediate layer was coated on the metal titanium substrate for 2 times by a thermal decomposition method (the total amount of platinum and iridium was 1.0 g/m², based on the metal content, for each coating), and the thermal decomposition was carried out at 500° C. for 20 minutes after each coating, to obtain the intermediate layer containing metal platinum and iridium dioxide. The total amount of platinum and iridium in the intermediate layer was 2.0 g/m², based on the metal content.

The substrate and the intermediate layer were sintered at 520° C. for 3 hours.

A coating solution for a catalyst layer was formulated as an n-butanol solution containing chloroiridic acid and tantalum ethoxide. Based on the metal content, the mass ratio of iridium to tantalum was 7:3 and the iridium content was 5.0 wt%. The coating solution for the catalyst layer was coated to the intermediate layer for 8 times by a thermal decomposition method (the amount of iridium was 1.0 g/m², based on the metal content, for each coating). The thermal decomposition was carried out at 450° C. for 20 minutes after each coating, to obtain the catalytic layer containing the mixed metal oxide of tantalum pentoxide and iridium dioxide. The total amount of iridium in the catalytic layer was 8.0 g/m², based on the metal content.

### Comparative Example 3

Gr1 grade industrial pure titanium was used as a substrate, subjected to the heat treatment at 500° C. for 1 hour, then etched in 7.5 wt% oxalic acid at 90° C. for 1 hour, cooled to 80° C. and continued to etch for 12 hours, washed in ultra-pure water by an ultrasonic device and dried in the air.

A coating solution for an intermediate layer was fomulated as an n-butanol solution containing tantalum ethoxide and tetrabutyl titanate. Based on the metal content, the mass ratio of tantalum to titanium was 7:3 and the tantalum content was 6.0 wt%. The coating solution for the intermediate layer was coated on the metal titanium substrate for 4 times by a thermal decomposition method (the amount of a mixed titanium-tantalum oxide was 0.75 g/m², based on the mixed oxide, for each coating), and the thermal decomposition was carried out at 520° C. for 20 minutes after each coating, to obtain the intermediate layer containing the mixed titanium-tantalum oxide. The content of the mixed titanium-tantalum oxide in the intermediate layer was 3.0 g/m², based on the content of mixed oxide.

A coating solution for a catalyst layer was formulated as an n-butanol solution containing chloroiridic acid and tantalum ethoxide. Based on the metal content, the mass ratio of iridium to tantalum was 7:3 and the iridium content was 6.0 wt%. The coating solution for the catalyst layer was coated to the intermediate layer for 10 times by a thermal decomposition method (the amount of iridium was 1.0 g/m², based on the metal content, for each coating). The thermal decomposition was carried out at 500° C. for 20 minutes after each coating, to obtain the catalytic layer containing the mixed metal oxide of tantalum pentoxide and iridium dioxide. The total amount of iridium in the catalytic layer was 10.0 g/m², based on the metal content.

### Performance Test

The positive polarity and negative polarity and current output of the rectifier were controlled by software, and the life test of the electrode was carried out under the following conditions.

### Test 1

The test conditions were: 5000 A/m², 15% sulfuric acid electrolyte, the time interval of polarity reversal was 5 min.

The accelerated life of the electrode of Example 3 was 2.8 Mah/m²;

The accelerated life of the electrode of Comparative Example 3 was 0.3 Mah/m².

### Test 2

The test conditions were: 45000 A/m², 80° C., 25% sulfuric acid electrolyte, without polarity reversal.

The accelerated life of the electrode of Example 3 was 27.0 Mah/m²;

The accelerated life of the electrode of Comparative Example 3 was 24.8 Mah/m².

Similarly, in the process of polarity reversal of the electrode, most of the deposits on the electrode are cleaned, thus realizing self-cleaning of the oxygen-evolution electrode. In addition, as compared with Comparative Example 3, Example 3 has an improved service life under the condition of direct current, but has a greatly prolonged life under the condition of polarity reversal.

### Example 4

Gr1 grade industrial pure titanium was used as a substrate, subjected to the heat treatment at 500° C. for 1 hour, then etched in 7.5 wt% oxalic acid at 90° C. for 1 hour, cooled to 80° C. and continued to etch for 12 hours, washed in ultra-pure water by an ultrasonic device and dried in the air.

A coating solution for an intermediate layer was fomulated as an n-butanol solution containing chloroiridic acid and chloroplatinic acid. Based on the metal content, the mass ratio of platinum to iridium was 6:4, the platinum content was 4.0 wt%, the concentration of HCl was 2.0 wt% (added as saturated hydrochloric acid), and the remaining component was n-butanol. The coating solution for the intermediate layer was coated on the metal titanium substrate for 4 times by a thermal decomposition method (the total amount of platinum and iridium was 1.25 g/m², based on the metal content, for each coating), and the thermal decomposition was carried out at 500° C. for 20 minutes after each coating, to obtain the intermediate layer containing metal platinum and iridium dioxide. The total amount of platinum and iridium in the intermediate layer was 5.0 g/m², based on the metal content.

The substrate and the intermediate layer were sintered at 520° C. for 4 hours.

A coating solution for a catalyst layer was formulated as an n-butanol solution containing chloroiridic acid and tantalum ethoxide. Based on the metal content, the mass ratio of iridium to tantalum was 8:2 and the iridium content was 4.5 wt%. The coating solution for the catalyst layer was coated to the intermediate layer for 10 times by a thermal decomposition method (the amount of iridium was 1.0 g/m², based on the metal content, for each coating). The thermal decomposition was carried out at 450° C. for 20 minutes after each coating, to obtain the catalytic layer containing the mixed metal oxide of tantalum pentoxide and iridium dioxide. The total amount of iridium in the catalytic layer was 10.0 g/m², based on the metal content.

### Comparative Example 4

Gr1 grade industrial pure titanium was used as a substrate, subjected to the heat treatment at 500° C. for 1 hour, then etched in 7.5 wt% oxalic acid at 90° C. for 1 hour, cooled to 80° C. and continued to etch for 12 hours, washed in ultra-pure water by an ultrasonic device and dried in the air.

A coating solution for an intermediate layer was fomulated as an n-butanol solution containing tantalum ethoxide and tetrabutyl titanate. Based on the metal content, the mass ratio of tantalum to titanium was 9:1 and the tantalum content was 6.0 wt%. The coating solution for the intermediate layer was coated on the metal titanium substrate for 4 times by a thermal decomposition method (the amount of a mixed titanium-tantalum oxide was 0.75 g/m², based on the mixed oxide, for each coating), and the thermal decomposition was carried out at 500° C. for 20 minutes after each coating, to obtain the intermediate layer containing the mixed titanium-tantalum oxide. The content of the mixed titanium-tantalum oxide in the intermediate layer was 3.0 g/m², based on the content of mixed oxide.

A coating solution for a catalyst layer was formulated as an n-butanol solution containing chloroiridic acid and tantalum ethoxide. Based on the metal content, the mass ratio of iridium to tantalum was 8:2 and the iridium content was 4.5 wt%. The coating solution for the catalyst layer was coated to the intermediate layer for 13 times by a thermal decomposition method (the amount of iridium was 1.0 g/m², based on the metal content, for each coating). The thermal decomposition was carried out at 500° C. for 20 minutes after each coating, to obtain the catalytic layer containing the mixed metal oxide of tantalum pentoxide and iridium dioxide. The total amount of iridium in the catalytic layer was 13.0 g/m², based on the metal content.

### Performance Test

The positive polarity and negative polarity and current output of the rectifier were controlled by software, and the life test of the electrode was carried out under the following conditions.

### Test 1

The test conditions were: 5000 A/m², 15% sulfuric acid electrolyte, the time interval of polarity reversal was 5 min.

The accelerated life of the electrode of Example 4 was 5.8 Mah/m²;

The accelerated life of the electrode of Comparative Example 4 was 0.3 Mah/m².

### Test 2

The test conditions were: 45000 A/m², 80° C., 25% sulfuric acid electrolyte, without polarity reversal.

The accelerated life of the electrode of Example 4 was 32.0 Mah/m²;

The accelerated life of the electrode of Comparative Example 4 was 37.8 Mah/m².

Similarly, in the process of polarity reversal of the electrode, most of the deposits on the electrode are cleaned, thus realizing self-cleaning of the oxygen-evolution electrode. In addition, as compared with Comparative Example 4, Example 4 has a comparable service life under the condition of direct current, but has a greatly prolonged life under the condition of polarity reversal.

### Example 5

Gr1 grade industrial pure titanium was used as a substrate, subjected to the heat treatment at 500° C. for 1 hour, then etched in 7.5 wt% oxalic acid at 90° C. for 1 hour, cooled to 80° C. and continued to etch for 12 hours, washed in ultra-pure water by an ultrasonic device and dried in the air.

A coating solution for an intermediate layer was fomulated as an n-butanol solution containing chloroiridic acid, chloroplatinic acid and ruthenium trichloride. Based on the metal content, the mass ratio of platinum: iridium: ruthenium was 60:35:5, the platinum content was 4.0 wt%, the concentration of HCl was 2.0 wt% (added as saturated hydrochloric acid), and the remaining component was n-butanol. The coating solution for the intermediate layer was coated on the metal titanium substrate for 6 times by a thermal decomposition method (the total amount of platinum and iridium was 1.25 g/m², based on the metal content, for each coating), and the thermal decomposition was carried out at 500° C. for 20 minutes after each coating, to obtain the intermediate layer containing metal platinum, ruthenium dioxide, and iridium dioxide. The total amount of platinum and iridium in the intermediate layer was 7.5 g/m², based on the metal content.

The substrate and the intermediate layer were sintered at 520° C. for 4 hours.

A coating solution for a catalyst layer was formulated as an n-butanol solution containing chloroiridic acid and tantalum ethoxide. Based on the metal content, the mass ratio of iridium to tantalum was 8:2 and the iridium content was 4.5 wt%. The coating solution for the catalyst layer was coated to the intermediate layer for 22 times by a thermal decomposition method (the amount of iridium was 1.0 g/m², based on the metal content, for each coating). The thermal decomposition was carried out at 450° C. for 20 minutes after each coating, to obtain the catalytic layer containing the mixed metal oxide of tantalum pentoxide and iridium dioxide. The total amount of iridium in the catalytic layer was 22.0 g/m², based on the metal content.

### Comparative Example 5

Gr1 grade industrial pure titanium was used as a substrate, subjected to the heat treatment at 500° C. for 1 hour, then etched in 7.5 wt% oxalic acid at 90° C. for 1 hour, cooled to 80° C. and continued to etch for 12 hours, washed in ultra-pure water by an ultrasonic device and dried in the air.

A coating solution for an intermediate layer was fomulated as an n-butanol solution containing tantalum ethoxide and tetrabutyl titanate. Based on the metal content, the mass ratio of tantalum to titanium was 9: 1 and the tantalum content was 6.0 wt%. The coating solution for the intermediate layer was coated on the metal titanium substrate for 4 times by a thermal decomposition method (the amount of a mixed titanium-tantalum oxide was 0.75 g/m², based on the mixed oxide, for each coating), and the thermal decomposition was carried out at 500° C. for 20 minutes after each coating, to obtain the intermediate layer containing the mixed titanium-tantalum oxide. The content of the mixed titanium-tantalum oxide in the intermediate layer was 3.0 g/m², based on the content of mixed oxide.

A coating solution for a catalyst layer was formulated as an n-butanol solution containing chloroiridic acid and tantalum ethoxide. Based on the metal content, the mass ratio of iridium to tantalum was 8:2 and the iridium content was 4.5 wt%. The coating solution for the catalyst layer was coated to the intermediate layer for 29 times by a thermal decomposition method (the amount of iridium was 1.0 g/m², based on the metal content, for each coating). The thermal decomposition was carried out at 500° C. for 20 minutes after each coating, to obtain the catalytic layer containing the mixed metal oxide of tantalum pentoxide and iridium dioxide. The total amount of iridium in the catalytic layer was 29.0 g/m², based on the metal content.

### Performance Test

The positive polarity and negative polarity and current output of the rectifier were controlled by software, and the life test of the electrode was carried out under the following conditions.

### Test 1

The test conditions were: 5000 A/m², 15% sulfuric acid electrolyte, the time interval of polarity reversal was 5 min.

The accelerated life of the electrode of Example 5 was 9.74 Mah/m²;

The accelerated life of the electrode of Comparative Example 5 was 0.3 Mah/m².

### Test 2

The test conditions were: 45000 A/m², 80° C., 25% sulfuric acid electrolyte, without polarity reversal.

The accelerated life of the electrode of Example 5 was 74.0 Mah/m²;

The accelerated life of the electrode of Comparative Example 5 was 57.8 Mah/m².

Similarly, in the process of polarity reversal of the electrode, most of the deposits on the electrode are cleaned, thus realizing self-cleaning of the oxygen-evolution electrode. In addition, as compared with Comparative Example 5, Example 5 has an improved service life under the condition of direct current, but has a greatly prolonged life under the condition of polarity reversal.

While the embodiments disclosed in the application are as above, the foregoing contents merely are embodiments employed for easy to understanding the application, and are not intended to limit the application. A person skilled in the art can make any modification and change to the forms and details of the embodiments without departing from the spirit and scope of the application, but the patent protection scope of the application shall subject to the scope defined by the appended claims.

What we claim is:

1. An electrode having polarity capable of being reversed comprising:
a substrate comprising a metal or an alloy thereof;
an intermediate layer arranged on the substrate and comprising a platinum group metal and a platinum group metal oxide; and
a catalytic layer arranged on the intermediate layer and comprising a mixed metal oxide.

2. The electrode according to claim 1, wherein the intermediate layer comprises a mixture of metal platinum and iridium dioxide.

3. The electrode according to claim 2, wherein the sum of the content of platinum and iridium of the intermediate layer is 1 g/m²-30 g/m², based on the metal content; preferably, the platinum content of the intermediate layer is 10 wt%-90 wt%, based on the total metal content of the intermediate layer; preferably, the iridium content of the intermediate layer is 10 wt%-90 wt%, based on the total metal content of the intermediate layer; preferably, based on the total metal content of the intermediate layer, the platinum content of the intermediate layer is 40 wt%-90 wt%, and the iridium content of the intermediate layer is 10 wt%-60 wt%.

4. The electrode according to claim 2 or claim 3, wherein the intermediate layer further comprises any one or more of ruthenium, palladium, and rhodium; preferably, the content of metal ruthenium, palladium, and rhodium in the intermediate layer is each less than 10 wt%, based on the total metal content of the intermediate layer.

5. The electrode according to any one of claims 1-4, wherein the platinum group metal of the intermediate layer diffuses into the substrate to form a mixed transition layer.

6. The electrode according to any one of claims 1-5, wherein the catalytic layer comprises a metal oxide of iridium; preferably, the catalytic layer comprises a mixed metal oxide of tantalum and iridium; preferably, the catalytic layer comprises tantalum pentoxide and iridium dioxide; preferably, the iridium content of the catalytic layer is 3 g/m²-100 g/m², based on the metal content; preferably, the iridium content of the catalytic layer is 20 wt%-90 wt%, based on the total metal content of the catalytic layer; preferably, the tantalum content of the catalytic layer is 10 wt%-80 wt%, based on the total metal content of the catalytic layer.

7. The electrode of claim 6, wherein the catalytic layer further comprises any one or more of ruthenium, palladium, rhodium, titanium, niobium, zirconium, hafnium, vanadium, molybdenum, and tungsten; preferably, the content of ruthenium, palladium, rhodium, titanium, niobium, zirconium, hafnium, vanadium, molybdenum and tungsten in the catalytic layer is each less than 10 wt%, based on the total metal content of the catalytic layer.

8. The electrode according to any one of claims 1-7, wherein the substrate is a valve-type metal or an alloy of valve-type metals; preferably, the valve-type metal is selected from one or more of titanium, tantalum, niobium, zirconium, hafnium, vanadium, molybdenum and tungsten; preferably, the substrate is metallic titanium or titanium alloy.

9. Use of an electrode according to any one of claims 1-8, as an electrode for electrolysis, electrodialysis or electroplating.

10. The use according to claim 9, wherein the electrode is an oxygen-evolution electrode.
